(19) United States
(12) Patent Application Publication
(10) Pub. No.: US 2026/0004784 A1
(43) Pub. Date: Jan. 1, 2026

(54) STREAMING SPEECH-TO-TEXT SYSTEM

(71) Applicant: Amazon Technologies, Inc., Seattle, WA (US)

(72) Inventors: FNU K P N V D S SIVA RAMA, Langley (CA); Mehul Rajesh KOTHARI, Seattle, WA (US); Vivek GOVINDAN, Maple Valley, WA (US)

(21) Appl. No.: 18/756,800

(22) Filed: Jun. 27, 2024

(51) Int. Cl. G10L 15/26; G10L 15/30

(52) U.S. Cl. CPC G10L 15/26; G10L 15/30

(57) ABSTRACT

Techniques for speech-to-text are described. Examples of a speech-to-text services are described. In some examples, the service performs speech-to-text according to the request using the speech-to-text service to generate the transcript from the audio stream by: determining a compute instance to send the request to based, at least in part, on availability information maintained in a distributed routing cache for a plurality of compute instances and types of speech-to-text processing indicated by the request, sending the request to the determined compute instance, and processing the request using the determined compute instance to generate the transcript.

### BACKGROUND

Speech-to-text systems employ a combination of machine learning models to accomplish its objectives including one or more of speech segmentation, speech recognition, punctuation, diarization, and speaker error correction. Most of these models are language-dependent, meaning that for each language introduced, the number of models required to be hosted increases.

### BRIEF DESCRIPTION OF DRAWINGS

Various examples in accordance with the present disclosure will be described with reference to the drawings, in which:

FIG. 1 illustrates examples of systems that include a speech-to-text service.

FIG. 2 illustrates examples of a speech-to-text service.

FIG. 3 illustrates examples of a speech-to-text service.

FIG. 4 illustrates examples of checkpointing.

FIG. 5 illustrates examples of methods for routing in the frontend for different worker sizes.

FIG. 6 illustrates examples of methods for routing in the backend for different worker sizes.

FIG. 7 illustrates examples of methods for re-balancing in the backend for different worker sizes.

FIG. 8 is a flow diagram illustrating operations of a method for performing speech-to-text according to some examples.

FIG. 9 illustrates an example cloud provider network environment according to some examples.

FIG. 10 is a block diagram of an example cloud provider network that provides a storage service and a hardware virtualization service to customers according to some examples.

FIG. 11 is a block diagram illustrating an example computing device that can be used in some examples.

### DETAILED DESCRIPTION

The present disclosure relates to methods, apparatus, systems, and non-transitory computer-readable storage media for a speech-to-text system. In speech-to-text systems that support many languages (e.g., 20+languages) it becomes necessary to host a substantial number of models. For the transcription of stored audio where latency is not an issue, it is not an issue to spin up models on-demand to perform the transcription. However, for support for real-time use cases such as live captioning and clinical notetaking it is not feasible to do this. Nor is it feasible to host all of these models simultaneously in a provider network environment as this ties up resources that could otherwise be used. As such, it would be power and compute inefficient to host everything at once.

In a standard streaming service setup, a public endpoint serves as the interface for receiving customer requests which are then directed to the appropriate back-end system housing the actual machine learning models. A standard solution uses a load balancer that is not efficient for a backend system due to the backend system's scalability. Further, traditional routing algorithms load balancers use such as round-robin are ineffective for services processing streams with varying durations (from seconds to hours) and/or maintaining a low number of active connections per instance, such as when only one stream is handled per instance. Load balancers also have an inability to differentiate instances based on their models necessitates the creation of multiple load balancers, leading to increased costs and operational overhead.

Detailed herein are examples of speech-to-text systems that use model caching, a distributed routing scheme, and re-balancing. These systems are capable of serving thousands of simultaneous instances while maintaining request routing within milliseconds. The caching capacity allows for dynamically registered instances with diverse configurations which may eliminate the need for additional infrastructure. Additionally, the caching enhances system availability and reduces latency by, in some examples, proactively refreshing cache in response to ongoing traffic patterns.

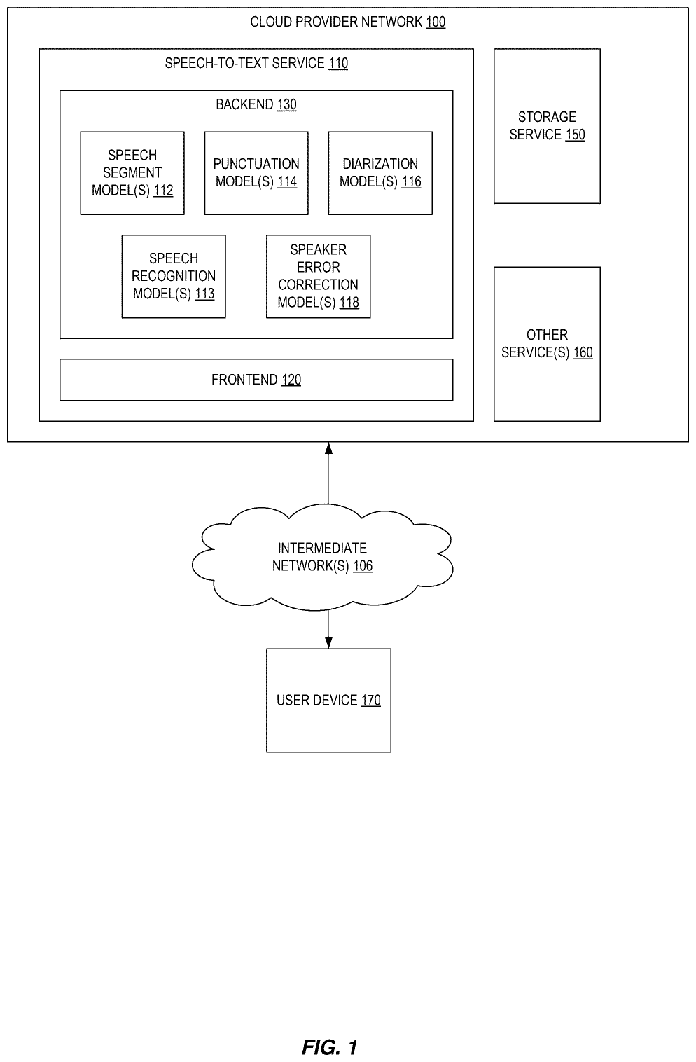

FIG. 1 illustrates examples of systems that include a speech-to-text service. As illustrated, the speech-to-text service 110 includes a frontend 120 that receives requests for speech-to-text (e.g., from a user device 170), routes requests to backend instances based on a distributed routing scheme and receives responses.

The backend 130 uses one or more models such as speech segmentation model(s) 112 that identify boundaries between words, syllables, or phonemes in natural language, punction model(s) 114 that predict punction for text, diarization model(s) 116 that identify speaker boundaries and group speaker segments, speech recognition model(s) 113 (also known as automatic speech recognition (ASR) that predict text from speech, and/or speaker error correction model(s) 118 which use, for example, lexical information to correct identified speakers (e.g., from the output of the ASR model(s) 113 and diarization model(s) 116). Note that one or more of the models of the backend 130 may be custom models. For example, a model trained by a user for a particular dialect, latency, etc. The backend 130 also communicates its availability to the frontend for use in the distributed routing scheme.

The backend 130 may also cache models, and restore models, as needed for a particular request or other reasons.

In some examples, the provider network 100 includes a storage service.

Other services 160 that are supported in some examples include, but are not limited to one or more of a streaming audio service to capture, container registry, a model registry, and/or produce streaming audio, streaming video service to capture and/or produce streaming video, etc.

One or more other service(s) 160 may also be provided by the provider network 100. For example, a video service (streaming and/or hosted) may be provided by the provider network 100. Videos that are streamed to a user may be passed to the speech-to-text service 110 to provide captions. Similarly, an audio service (streaming and/or hosted), an audio chat service, etc. may use the speech-to-text service 110 to provide transcripts and/or captions.

In some examples, the output of the speech-to-text service 110 is stored in storage service 150. For example, the storage service 150 may be used to store captions for a particular video.

A cloud provider network 100 (also referred to herein as a provider network, service provider network, etc.) provides users with the ability to use one or more of a variety of types of computing-related resources such as compute resources (e.g., executing virtual machine (VM) instances and/or containers, executing batch jobs, executing code without provisioning servers), data/storage resources (e.g., object storage, block-level storage, data archival storage, databases and database tables, etc.), network-related resources (e.g., configuring virtual networks including groups of compute resources, content delivery networks (CDNs), Domain Name Service (DNS)), application resources (e.g., databases, application build/deployment services), access policies or roles, identity policies or roles, machine images, routers and other data processing resources, etc. These and other computing resources can be provided as services, such as a hardware virtualization service that can execute compute instances, a storage service that can store data objects, etc. The users (or “customers”) of cloud provider networks 100 can use one or more user accounts that are associated with a customer account, though these terms can be used somewhat interchangeably depending upon the context of use. Cloud provider networks are sometimes “multi-tenant” as they can provide services to multiple different customers using the same physical computing infrastructure; for example, virtual machine instances may be concurrently hosted for different customers using a same underlying physical host computing device.

Users can interact with a cloud provider network 100 across one or more intermediate networks 106 (e.g., the internet) via one or more interface(s), such as through use of application programming interface (API) calls, via a console implemented as a website or application, etc. An API refers to an interface and/or communication protocol between a client and a server, such that if the client makes a request in a predefined format, the client should receive a response in a specific format or initiate a defined action. In the cloud provider network context, APIs provide a gateway for customers to access cloud infrastructure by allowing customers to obtain data from or cause actions within the cloud provider network, enabling the development of applications that interact with resources and services hosted in the cloud provider network. APIs can also enable different services of the cloud provider network to exchange data with one another. The interface(s) can be part of, or serve as a front-end to, a control plane of the cloud provider network 100 that includes “backend” services supporting and enabling the services that can be more directly offered to customers.

Thus, a cloud provider network (or just “cloud”) typically refers to a large pool of accessible virtualized computing resources (such as compute, storage, and networking resources, applications, and services). A cloud can provide convenient, on-demand network access to a shared pool of configurable computing resources that can be programmatically provisioned and released in response to customer commands. These resources can be dynamically provisioned and reconfigured to adjust to variable load. Cloud computing can thus be considered as both the applications delivered as services over a publicly accessible network (e.g., the Internet, a cellular communication network) and the hardware and software in cloud provider data centers that provide those services.

A cloud provider network can be formed as a number of regions, where a region is a geographical area in which the cloud provider clusters data centers. Each region includes multiple (e.g., two or more) availability zones (AZs) connected to one another via a private high-speed network, for example a fiber communication connection. An AZ (also known as a “zone”) provides an isolated failure domain including one or more data center facilities with separate power, separate networking, and separate cooling from those in another AZ. A data center refers to a physical building or enclosure that houses and provides power and cooling to servers of the cloud provider network. Preferably, AZs within a region are positioned far enough away from one another so that a natural disaster (or other failure-inducing event) should not affect or take more than one AZ offline at the same time.

Users can connect to an AZ of the cloud provider network via a publicly accessible network (e.g., the Internet, a cellular communication network), e.g., by way of a transit center (TC). TCs are the primary backbone locations linking users to the cloud provider network and can be collocated at other network provider facilities (e.g., Internet service providers (ISPs), telecommunications providers) and securely connected (e.g., via a VPN or direct connection) to the AZs. Each region can operate two or more TCs for redundancy. Regions are connected to a global network which includes private networking infrastructure (e.g., fiber connections controlled by the cloud provider) connecting each region to at least one other region. The cloud provider network can deliver content from points of presence (or “POPs”) outside of, but networked with, these regions by way of edge locations and regional edge cache servers. This compartmentalization and geographic distribution of computing hardware enables the cloud provider network to provide low-latency resource access to users on a global scale with a high degree of fault tolerance and stability.

An on-demand code execution service (referred to in various examples as a function compute service, functions service, cloud functions service, functions as a service, or serverless computing service) can enable users of the cloud provider network 100 to execute their code on cloud resources without having to select or manage the underlying hardware resources used to execute the code. For example, a user can use an on-demand code execution service by uploading their code and use one or more APIs to request that the service identify, provision, and manage any resources required to run the code. Thus, in various examples, a “serverless” function can include code provided by a user or other entity—such as the provider network itself—that can be executed on demand. Serverless functions can be maintained within the provider network by an on-demand code execution service and can be associated with a particular user or account or can be generally accessible to multiple users/accounts. A serverless function can be associated with a Uniform Resource Locator (URL), Uniform Resource Identifier (URI), or other reference, which can be used to invoke the serverless function. A serverless function can be executed by a compute resource, such as a virtual machine, container, etc., when triggered or invoked. In some examples, a serverless function can be invoked through an application programming interface (API) call or a specially formatted HyperText Transport Protocol (HTTP) request message. Accordingly, users can define serverless functions that can be executed on demand, without requiring the user to maintain dedicated infrastructure to execute the serverless function. Instead, the serverless functions can be executed on demand using resources maintained by the cloud provider network 100. In some examples, these resources can be maintained in a “ready” state (e.g., having a pre-initialized runtime environment configured to execute the serverless functions), allowing the serverless functions to be executed in near real-time.

A hardware virtualization service (referred to in various implementations as an elastic compute service, a virtual machines service, a computing cloud service, a compute engine, or a cloud compute service) can enable users of the cloud provider network 100 to provision and manage compute resources such as virtual machine instances. Virtual machine technology can use one physical server to run the equivalent of many servers (each of which is called a virtual machine), for example using a hypervisor, which can run at least partly on an offload card of the server (e.g., a card connected via PCI or PCIe to the physical CPUs) and other components of the virtualization host can be used for some virtualization management components. Such an offload card of the host can include one or more CPUs that are not available to user instances, but rather are dedicated to instance management tasks such as virtual machine management (e.g., a hypervisor), input/output virtualization to network-attached storage volumes, local migration management tasks, instance health monitoring, and the like). Virtual machines are commonly referred to as compute instances or simply “instances.” As used herein, provisioning a virtual compute instance generally includes reserving resources (e.g., computational and memory resources) of an underlying physical compute instance for the client (e.g., from a pool of available physical compute instances and other resources), installing or launching required software (e.g., an operating system), and making the virtual compute instance available to the client for performing tasks specified by the client.

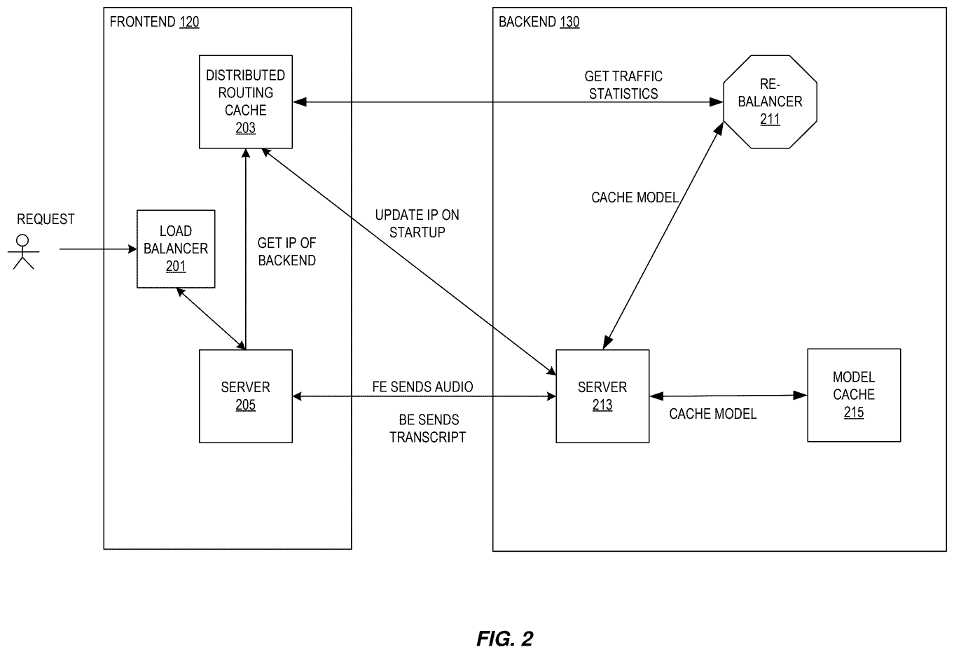

FIG. 2 illustrates examples of a speech-to-text service. At any given time, a backend host instance (e.g., server 213) may host one or multiple active models. For example, there may be one or more speech segment model(s) 112, punctuation model(s) 114, diarization model(s) 116, speech recognition model(s) 113, and/or speaker error correction model(s) 118 that are active. In some examples, one or more of these model types is language dependent (such as, for example, speech segmentation, punctuation, and/or speech recognition). In some examples, groups of instances are fleets. Depending on the type of instance, the number of models and their specific requirements, a system can comprise of one or more fleets.

As physical resources are limited, a backend host instance may need to cache one or models to a model cache 215. In some examples, more frequently used models (e.g., based on past usage) are cached into the model cache 215 at start up in some examples. Note that the model cache 215 is local to the instance in some examples. Retrieving a cached model is more efficient than downloading the models from a different server, etc. Downloading would cause seconds of streaming start delay.

However, if the number of models is extensive, they may exceed memory capacity, resulting in increased latencies during the switching of cached models. To mitigate the impact on the system, reducing the frequency of model switches would be beneficial. A fleet or model re-balancer 211 monitors traffic patterns (shown as traffic statistics which it receives from the distributed routing cache 203) and performs proactive model switching which should thereby optimizing resource utilization and minimizing latencies. In particular, the re-balancer 211 instructions backend hosts to download, cache, and/or active models. In some examples, the re-balance is on a global level (that is across a fleet or fleets).

In some examples, there are at least two scenarios where re-balancing may be used. First, when new instances are launched, the re-balancer 211 determines which model to use. Second, when there is continuous traffic or reduction in traffic, the weightage of each model changes. The re-balancer 211 may perform periodic or ad-hoc re-balancing based on the traffic patterns.

The frontend 120 utilizes a distributed routing cache 203 to determine an appropriate backend host instance (an example of a host is shown as server 213). The distributed routing cache 203 correlates a plurality of backend servers (e.g., server 213) that host one or more models used for STT with their addresses (e.g., internet protocol (IP) addresses).

The distributed routing cache 203, in some examples, utilizes a key-value architecture. Entries in the distributed routing cache 203 may comprise a server (or fleet) ID as the key and a set containing IP addresses of compute instances as the value. In some examples, an in-memory database is used for the distributed routing cache 203.

In some examples, for backend host instances supporting multiple streams, each backend host instance registers IPs with unique identifiers (UUIDs), such as IP-UUID1, IP-UUID2, etc. with the distributed routing cache 203. The frontend 120 can retrieve the IP by removing the UUID and connect to the instance accordingly.

In some examples, to handle different weighted workers within a backend host instance—where, for example, model-1 utilizes X % CPU while model-2 utilizes Y % CPU—the backend host instance registers its IP address into distinct sets indicating the types of streams it can support. For example, for a fleet, there might be sets like fleet1-SMALL, fleet1-MEDIUM, etc. where the higher the classification the more resources are available. For example, a small classification uses less resources than a large classification. Higher stream classifications may be a fallback if smaller stream types are not available.

Backend host instances can dynamically register additional workers if they are inefficient in terms of CPU and memory usage and/or if all existing workers are occupied in some examples. The distributed routing cache 203 entry will be updated with new worker information.

In some examples, upon its startup, a backend host instance registers its IP address in the distributed routing cache 203 and marks itself as available.

In some examples, the distributed routing cache 203 includes an autoscaling entry dedicated to tracking busy workers for each fleet which is populated as the frontend server 205 system selects a worker to serve a stream.

An example of a flow for this illustration is as follows. First, a user initiates a start of a stream to transcribe by a request. In some examples, a load balancer 201 receives this request (and other requests) and communicates with a client side compute instance (server 205) to service the transcription request. Note that transcription request may include one or more of: an indication of the language(s) being used, an indication of a latency that is acceptable, an indication of where the stream is located (e.g., a URL for the stream), an indication of the types of SST operations to perform (e.g., perform diarization, etc.), an indication of a model or models to use (e.g., a custom model or model to use), etc.

The server 205 looks up an appropriate backend host (e.g., IP) from the distributed routing cache 203. In some examples, an IP address is selected (and removed) randomly from the set of IPs of the distributed routing cache 203.

Examples of this decision are detailed below. With an IP, the server 205 sends audio to the backend host instance (e.g., server 213) which handles the request using one or more models and sends back a transcript.

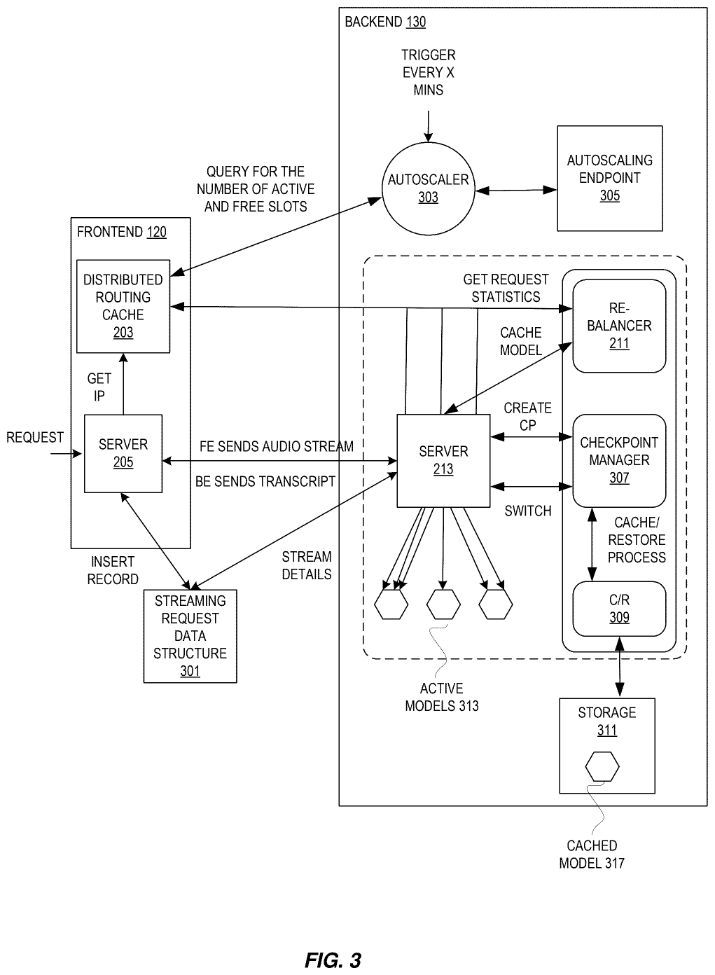

FIG. 3 illustrates examples of a speech-to-text service. Descriptions of components described with respect to FIG. 1 are not repeated. Shown in this illustration is a streaming request data structure 301 that stores details about transcription requests. The server 213 uses those records in serving requests.

As illustrated, the re-balancer 211 acquires usages statistics from the distributed routing cache 203 to make requests for the server 213 to cache one or more active models 313.

The server 213 uses a checkpoint manager 307 to manage checkpoints which comprise state data that can be used to restore a model and run the model as if it had not been saved. In some examples, what is checkpointed is a container.

A checkpoint/restore (C/R) component 309 freezes a running container (or model) and performs the checkpointing of its state to storage 311 (for example, cached model 317 has had its state checkpointed). In some examples, the C/R 309 can switch between models in under a second. Upon startup, the server 213 causes the generation of checkpoints for all necessary models and saves them in storage 311. This efficiency is beneficial for streaming applications and improves latency and availability.

Depending on available resources, these checkpoints can be stored either in-memory or on disk (simply shown as storage 311). In some examples, the top N models are cached in memory while storing the remaining ones on disk or other storage solution.

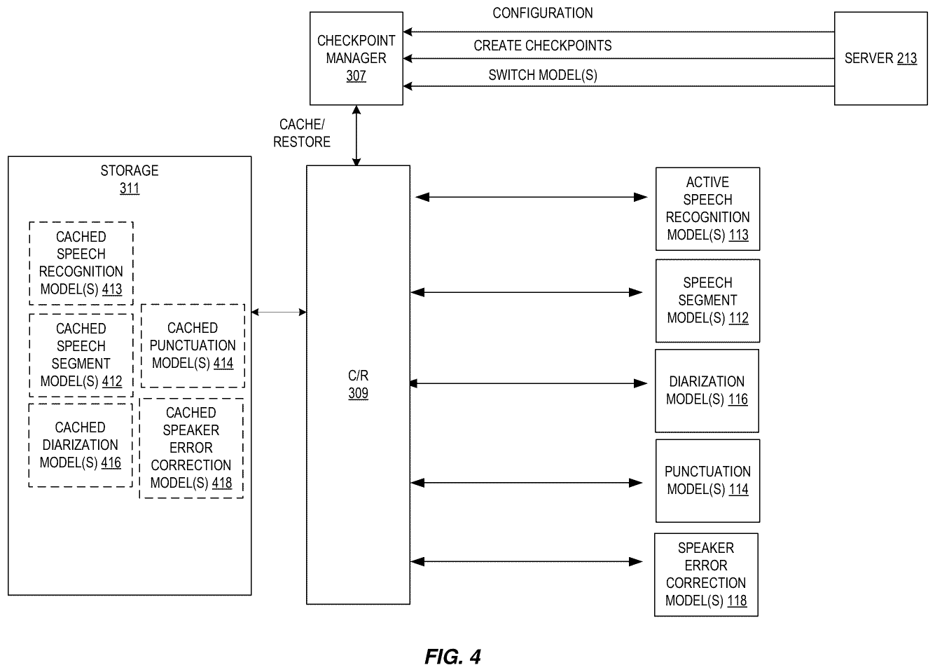

FIG. 4 illustrates examples of checkpointing. As shown, the server 213 configures the checkpoint manager 307 (e.g., details where to cache models, etc.), provides a command to create checkpoints (which the C/R 309 does by saving (or caching) state to storage 311 (shown as cached models 412-418), and provides a command to switch models (which causes the C/R 309 to cache state for one or more models and restore state for one or more models).

Also shown is an auto-scaler 303 that is, in some examples, triggered periodically to query the distributed routing cache 203 for the number of active slots and the number of free slots. The types may be based on complexity of a given task (e.g., a complex task of five different model types would require a large slot with resources capable of handle the task and a relatively simple task (e.g., only ASR) would require a smaller slot. The cardinality of these entries in the distributed routing cache 203 is used to determine the system load and available capacity which are published to an autoscaling endpoint 305 which performs the autoscaling of resources (e.g., servers, memory, compute hardware, etc.) of the backend 130 and/or frontend 120 as needed. For example, in some examples, the distributed routing cache 203 may include an autoscaling entry dedicated to tracking busy workers (tracking the number of active versus free slots) for each fleet which is populated as the frontend server 205 system selects a worker to serve a stream and this information to perform autoscaling of at least backend resources.

It may be important that the re-balancing be done on each of the instances independently, as synchronization across thousands of instances will be challenging without having a centralized decision-making entity. To achieve this, a randomized algorithm described below can be run periodically.

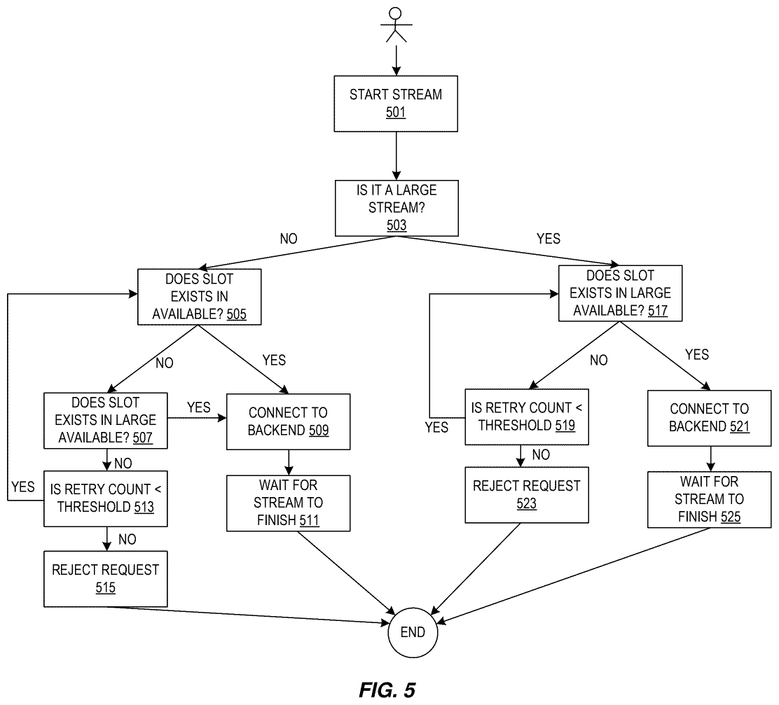

As noted earlier, a fleet may have different “sized” workers. FIG. 5 illustrates examples of methods for routing in the frontend for different worker sizes. Some or all of the operations (or other processes described herein, or variations, and/or combinations thereof) are performed under the control of one or more computing devices configured with executable instructions, and are implemented as code (e.g., executable instructions, one or more computer programs, or one or more applications) executing collectively on one or more processors. The code is stored on a computer-readable storage medium, for example, in the form of a computer program comprising instructions executable by one or more processors. The computer-readable storage medium is non-transitory. In some examples, one or more (or all) of the operations are performed by the frontend 120 of the other figures.

A user requests a transcription at 501. A determination of if the stream is “large” or not is determined at 503. For example, the server 205 interprets the request to determine how many resources (e.g., models) the request requires. For example, if only ASR is required that is not a “large” request, but if all five detailed models are required that is a large request.

When the stream is not large, a determination is made of if a slot exists in the distributed routing cache 203 that is marked as available for a size smaller than large at 505. Note that if “large” is the largest possible size, then this determination is if any slot is not large. If not, then a determination is made of if there is a large slot available at 507. As noted above, the “large” size can accommodate smaller requests. If there is an available large slot, or there is a smaller size slot available, then a connection is made to the backend 130 at 509. The frontend then waits for the stream to finish (e.g., a transcription is received) at 511.

If there are not slots available, in some examples, a retry count is incremented and if it is below a threshold at 513, then the determination of 505 is performed again. If the threshold has been exceeded, then the request to perform a transcription is rejected at 515.

When the stream is large, a determination is made of if a slot exists in the distributed routing cache 203 that is marked as available for the large size at 517. If there is an available large slot, then a connection is made to the backed 120 at 521. The frontend then waits for the stream to finish (e.g., a transcription is received) at 525.

If there are not larges slots available, in some examples, a retry count is incremented and if it is below a threshold at 519, then the determination of 517 is performed again. If the threshold has been exceeded, then the request to perform a transcription is rejected at 523.

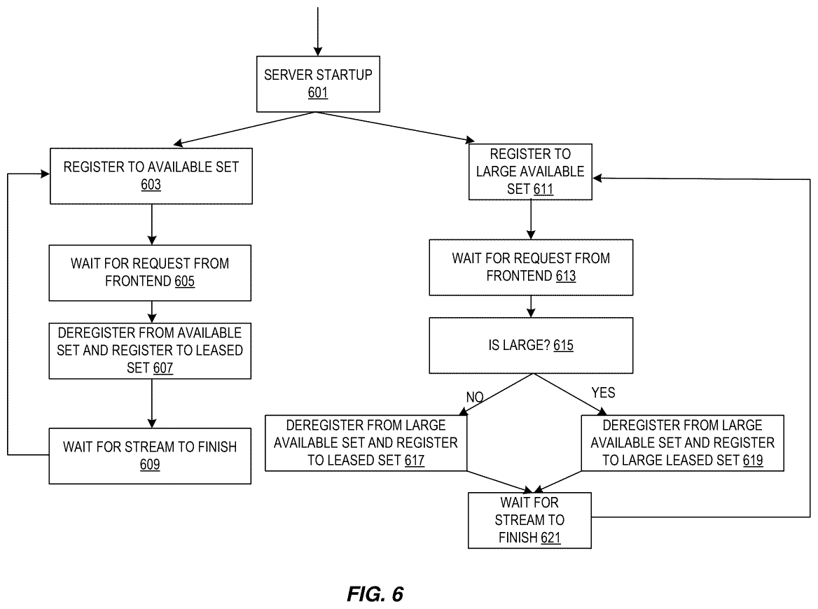

FIG. 6 illustrates examples of methods for routing in the backend for different worker sizes. Some or all of the operations (or other processes described herein, or variations, and/or combinations thereof) are performed under the control of one or more computing devices configured with executable instructions, and are implemented as code (e.g., executable instructions, one or more computer programs, or one or more applications) executing collectively on one or more processors. The code is stored on a computer-readable storage medium, for example, in the form of a computer program comprising instructions executable by one or more processors. The computer-readable storage medium is non-transitory. In some examples, one or more (or all) of the operations are performed by the backend 130 of the other figures.

Upon a server startup at 601, one or more models are loaded. The backend server (e.g., server 213) registers its capabilities and availabilities. In this illustration, there are two types of capabilities-large and non-large.

At 603 non-large capabilities are registered to non-large availability in the distributed routing cache 203. Once the registration has occurred, the backend 130 waits for a request from the frontend 120 at 605. When a request comes in, the server 213 causes the registration in the distributed routing cache 203 to change from available to leased (or used) at 607 and uses the model(s) to perform the transcription. When the stream has finished at 609, the registration is changed back to available.

At 611 large capabilities are registered to large availability in the distributed routing cache 203. Once the registration has occurred, the backend 130 waits for a request from the frontend 120 at 613. When a request comes in, a determination of if the request is for a large capability is made at 615. If not, then the server 213 causes the registration in the distributed routing cache 203 to change from large available to non-large leased (or used) at 617 and uses the model(s) to perform the transcription. If not, then the server 213 causes the registration in the distributed routing cache 203 to change from large available to large leased (or used) at 619 and uses the model(s) to perform the transcription. When the stream has finished at 621, the registration is changed back to large available.

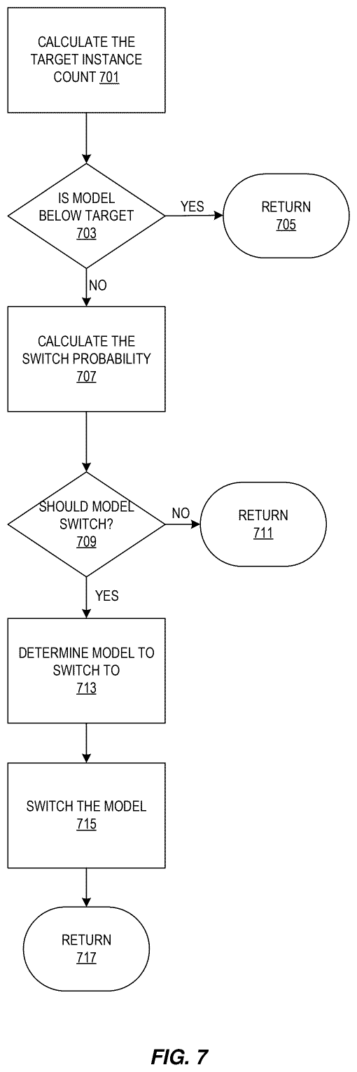

FIG. 7 illustrates examples of methods for re-balancing in the backend for different worker sizes. Some or all of the operations (or other processes described herein, or variations, and/or combinations thereof) are performed under the control of one or more computing devices configured with executable instructions, and are implemented as code (e.g., executable instructions, one or more computer programs, or one or more applications) executing collectively on one or more processors. The code is stored on a computer-readable storage medium, for example, in the form of a computer program comprising instructions executable by one or more processors. The computer-readable storage medium is non-transitory. In some examples, one or more (or all) of the operations are performed by the backend 130 of the other figures.

At 701 a target instance count is calculated at 701. For example, for a given model how many instances or workers are needed to utilize the model and meet latency, etc. requirements.

A determination of if the model usage is below the target instance count is made at 703. When it is, then no re-balancing needs to occur, and the re-balancer returns to a wait state at 705. When the model usage is above the target instance count, then a calculation of a switch probability for the model is made at 707. For example, what is the probability that the instance needs to switch the model from an existing model may be calculated. For example, what is the probability that a given model is not needed versus being needed.

A determination is then made, based on the switch probability, if the model should be switched at 709. If not, then no re-balancing needs to occur, and the re-balancer returns to a wait state at 705. If so, a determination of which model to switch to is made at 713 and the models are switched at 715. The switching of models may include checkpointing one or more models and restoring one or more models. After the switching the re-balancer returns to a wait state at 717.

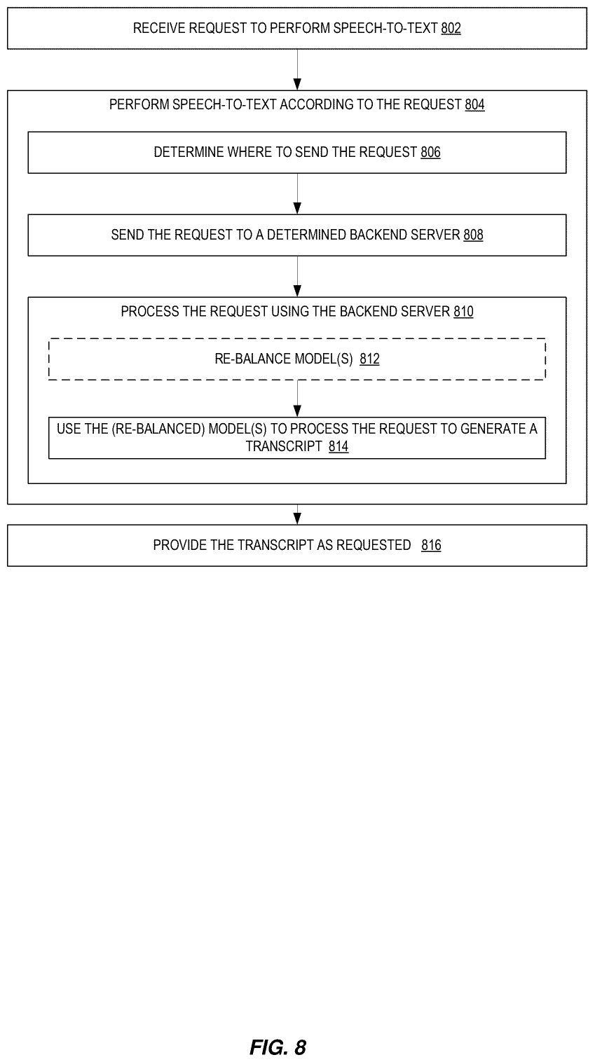

FIG. 8 is a flow diagram illustrating operations of a method for performing speech-to-text according to some examples. Some or all of the operations (or other processes described herein, or variations, and/or combinations thereof) are performed under the control of one or more computing devices configured with executable instructions, and are implemented as code (e.g., executable instructions, one or more computer programs, or one or more applications) executing collectively on one or more processors. The code is stored on a computer-readable storage medium, for example, in the form of a computer program comprising instructions executable by one or more processors. The computer-readable storage medium is non-transitory. In some examples, one or more (or all) of the operations are performed by the STT service 110 of the other figures.

A request to perform speech-to-text is received at 802. In some examples, the request includes one or more of: an indication of what STT types of models to use, an indication of what STT models to use, an indication of a latency requirement, an indication of a storage location of audio to transcribe, an indication of a model or models to use, an indication of a streaming location of audio to transcribe, an indication of a language of the audio, etc. Note the set of models (or types of models) dictated by the request will determine the size of the request.

Speech-to-text according is performed according to the request 804. One or more acts may comprise this performance. A determination of where to send the request is made at 806. This determination is made by a frontend such as frontend 120. This determination utilizes a distributed routing cache 203 as discussed above. FIG. 5 illustrates examples of determining where to send the audio stream based on its size.

The frontend (e.g., server 205) sends the request to a determined backend server at 808. The request is then processed using the backend server at 810.

In some examples, the model(s) of the backend server are re-balanced at 812. Examples of re-balancing have been detailed above. In some examples, re-balancing is performed in response to a request for STT. For example, if the request calls for one or more models that are not currently active, the backend server will make those one or more models active. To do this, the backend server may checkpoint one or more cached models, restore one or more cached models, and/or download one or more models.

Once the re-balancing has occurred, or if it is not necessary, the (re-balanced) model(s) are used to process the request to generate a transcript at 814. Note that the backend server will also alert the distributed routing cache 203 of the status of its slot usage to perform the request upon re-balancing and/or the start of transcription. Once the audio has been processed, the backend server alerts the distributed routing cache 203 of the change in status of its slots.

The transcript is provided as requested at 816.

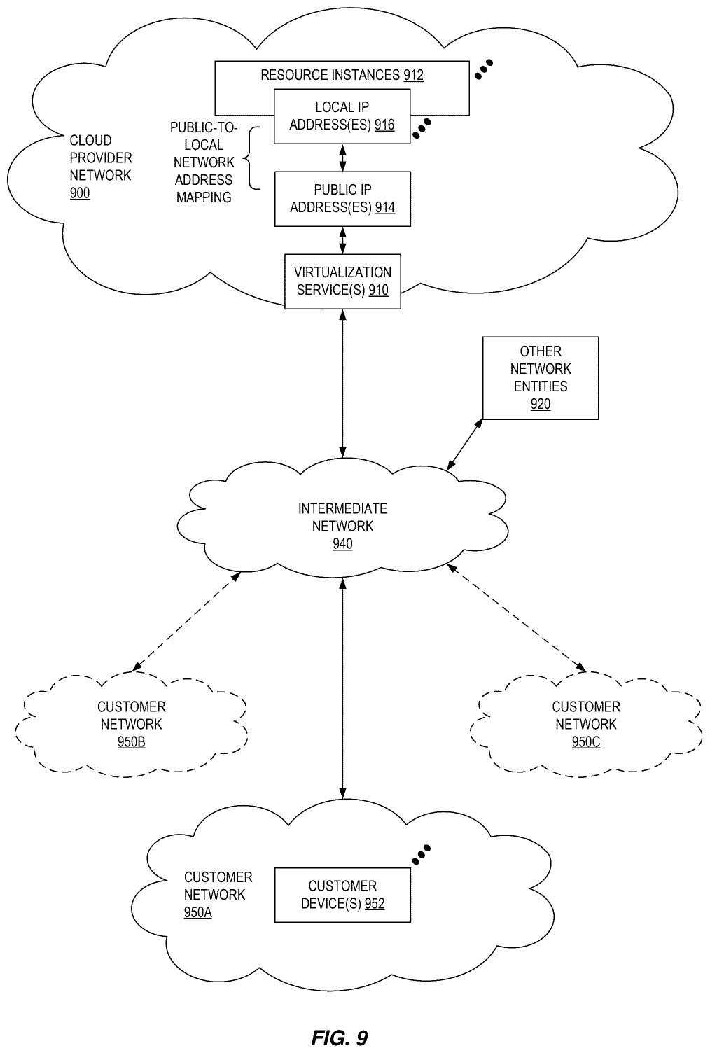

FIG. 9 illustrates an example provider network (or “service provider system”) environment according to some examples. A provider network 900 can provide resource virtualization to customers via one or more virtualization services 910 that allow customers to purchase, rent, or otherwise obtain instances 912 of virtualized resources, including but not limited to computation and storage resources, implemented on devices within the provider network or networks in one or more data centers. Local Internet Protocol (IP) addresses 916 can be associated with the resource instances 912; the local IP addresses are the internal network addresses of the resource instances 912 on the provider network 900. In some examples, the provider network 900 can also provide public IP addresses 914 and/or public IP address ranges (e.g., Internet Protocol version 4 (IPv4) or Internet Protocol version 6 (IPv6) addresses) that customers can obtain from the provider 900.

Conventionally, the provider network 900, via the virtualization services 910, can allow a customer of the service provider (e.g., a customer that operates one or more customer networks 950A-950C (or “client networks”) including one or more customer device(s) 952) to dynamically associate at least some public IP addresses 914 assigned or allocated to the customer with particular resource instances 912 assigned to the customer. The provider network 900 can also allow the customer to remap a public IP address 914, previously mapped to one virtualized computing resource instance 912 allocated to the customer, to another virtualized computing resource instance 912 that is also allocated to the customer. Using the virtualized computing resource instances 912 and public IP addresses 914 provided by the service provider, a customer of the service provider such as the operator of the customer network(s) 950A-950C can, for example, implement customer-specific applications and present the customer's applications on an intermediate network 940, such as the Internet. Other network entities 920 on the intermediate network 940 can then generate traffic to a destination public IP address 914 published by the customer network(s) 950A-950C; the traffic is routed to the service provider data center, and at the data center is routed, via a network substrate, to the local IP address 916 of the virtualized computing resource instance 912 currently mapped to the destination public IP address 914. Similarly, response traffic from the virtualized computing resource instance 912 can be routed via the network substrate back onto the intermediate network 940 to the source entity 920.

Local IP addresses, as used herein, refer to the internal or “private” network addresses, for example, of resource instances in a provider network. Local IP addresses can be within address blocks reserved by Internet Engineering Task Force (IETF) Request for Comments (RFC) 1918 and/or of an address format specified by IETF RFC 4193 and can be mutable within the provider network. Network traffic originating outside the provider network is not directly routed to local IP addresses; instead, the traffic uses public IP addresses that are mapped to the local IP addresses of the resource instances. The provider network can include networking devices or appliances that provide network address translation (NAT) or similar functionality to perform the mapping from public IP addresses to local IP addresses and vice versa.

Public IP addresses are Internet mutable network addresses that are assigned to resource instances, either by the service provider or by the customer. Traffic routed to a public IP address is translated, for example via 1:1 NAT, and forwarded to the respective local IP address of a resource instance.

Some public IP addresses can be assigned by the provider network infrastructure to particular resource instances; these public IP addresses can be referred to as standard public IP addresses, or simply standard IP addresses. In some examples, the mapping of a standard IP address to a local IP address of a resource instance is the default launch configuration for all resource instance types.

At least some public IP addresses can be allocated to or obtained by customers of the provider network 900; a customer can then assign their allocated public IP addresses to particular resource instances allocated to the customer. These public IP addresses can be referred to as customer public IP addresses, or simply customer IP addresses. Instead of being assigned by the provider network 900 to resource instances as in the case of standard IP addresses, customer IP addresses can be assigned to resource instances by the customers, for example via an API provided by the service provider. Unlike standard IP addresses, customer IP addresses are allocated to customer accounts and can be remapped to other resource instances by the respective customers as necessary or desired. A customer IP address is associated with a customer's account, not a particular resource instance, and the customer controls that IP address until the customer chooses to release it. Unlike conventional static IP addresses, customer IP addresses allow the customer to mask resource instance or availability zone failures by remapping the customer's public IP addresses to any resource instance associated with the customer's account. The customer IP addresses, for example, enable a customer to engineer around problems with the customer's resource instances or software by remapping customer IP addresses to replacement resource instances.

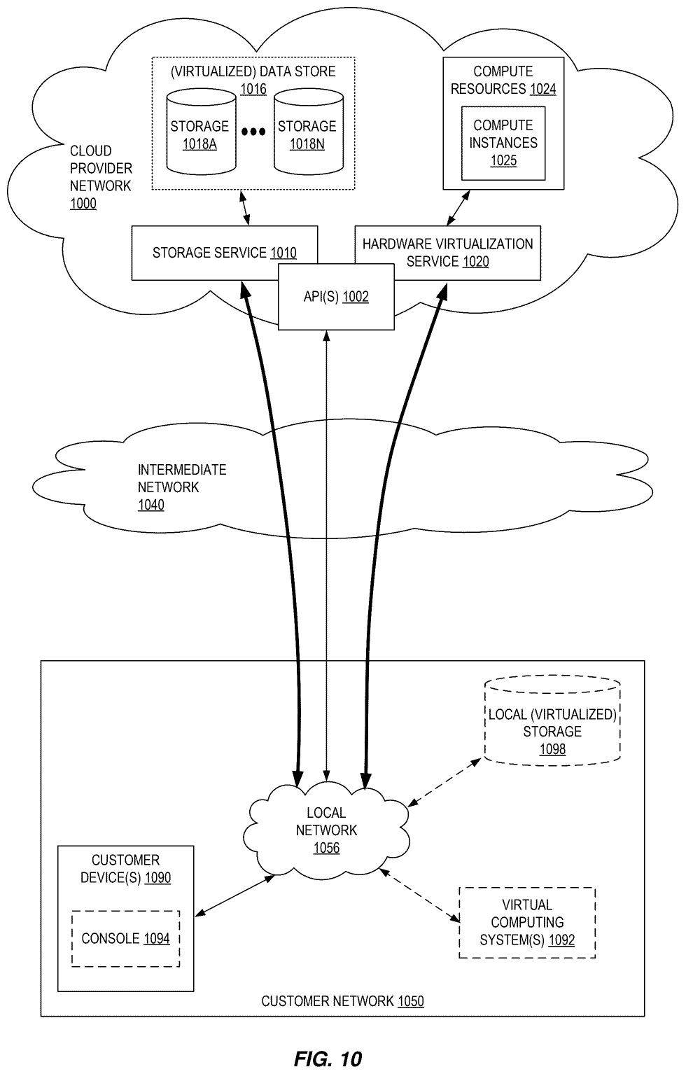

FIG. 10 is a block diagram of an example provider network environment that provides a storage service and a hardware virtualization service to customers, according to some examples. A hardware virtualization service 1020 provides multiple compute resources 1024 (e.g., compute instances 1025, such as VMs) to customers. The compute resources 1024 can, for example, be provided as a service to customers of a provider network 1000 (e.g., to a customer that implements a customer network 1050). Each computation resource 1024 can be provided with one or more local IP addresses. The provider network 1000 can be configured to route packets from the local IP addresses of the compute resources 1024 to public Internet destinations, and from public Internet sources to the local IP addresses of the compute resources 1024.

The provider network 1000 can provide the customer network 1050, for example coupled to an intermediate network 1040 via a local network 1056, the ability to implement virtual computing systems 1092 via the hardware virtualization service 1020 coupled to the intermediate network 1040 and to the provider network 1000. In some examples, the hardware virtualization service 1020 can provide one or more APIs 1002, for example a web services interface, via which the customer network 1050 can access functionality provided by the hardware virtualization service 1020, for example via a console 1094 (e.g., a web-based application, standalone application, mobile application, etc.) of a customer device 1090. In some examples, at the provider network 1000, each virtual computing system 1092 at the customer network 1050 can correspond to a computation resource 1024 that is leased, rented, or otherwise provided to the customer network 1050.

From an instance of the virtual computing system(s) 1092 and/or another customer device 1090 (e.g., via console 1094), the customer can access the functionality of a storage service 1010, for example via the one or more APIs 1002, to access data from and store data to storage resources 1018A-1018N of a virtual data store 1016 (e.g., a folder or “bucket,” a virtualized volume, a database, etc.) provided by the provider network 1000. In some examples, a virtualized data store gateway (not shown) can be provided at the customer network 1050 that can locally cache at least some data, for example frequently accessed or critical data, and that can communicate with the storage service 1010 via one or more communications channels to upload new or modified data from a local cache so that the primary store of data (the virtualized data store 1016) is maintained. In some examples, a user, via the virtual computing system 1092 and/or another customer device 1090, can mount and access virtual data store 1016 volumes via the storage service 1010 acting as a storage virtualization service, and these volumes can appear to the user as local (virtualized) storage 1098.

While not shown in FIG. 10, the virtualization service(s) can also be accessed from resource instances within the provider network 1000 via the API(s) 1002. For example, a customer, appliance service provider, or other entity can access a virtualization service from within a respective virtual network on the provider network 1000 via the API(s) 1002 to request allocation of one or more resource instances within the virtual network or within another virtual network.

### Illustrative Systems

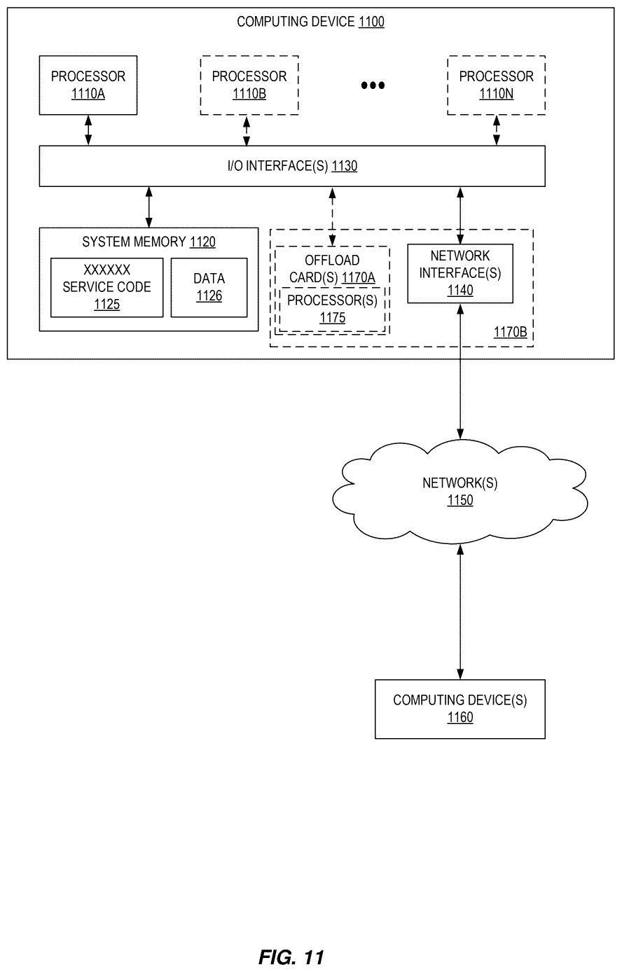

In some examples, a system that implements a portion or all of the techniques described herein can include a general-purpose computer system, such as the computing device 1100 (also referred to as a computing system or electronic device) illustrated in FIG. 11, that includes, or is configured to access, one or more computer-accessible media. In the illustrated example, the computing device 1100 includes one or more processors 1110 coupled to a system memory 1120 via an input/output (I/O) interface 1130. The computing device 1100 further includes a network interface 1140 coupled to the I/O interface 1130. While FIG. 11 shows the computing device 1100 as a single computing device, in various examples the computing device 1100 can include one computing device or any number of computing devices configured to work together as a single computing device 1100.

In various examples, the computing device 1100 can be a uniprocessor system including one processor 1110, or a multiprocessor system including several processors 1110 (e.g., two, four, eight, or another suitable number). The processor(s) 1110 can be any suitable processor(s) capable of executing instructions. For example, in various examples, the processor(s) 1110 can be general-purpose or embedded processors implementing any of a variety of instruction set architectures (ISAs), such as the x86, ARM, PowerPC, SPARC, or MIPS ISAs, or any other suitable ISA. In multiprocessor systems, each of the processors 1110 can commonly, but not necessarily, implement the same ISA.

The system memory 1120 can store instructions and data accessible by the processor(s) 1110. In various examples, the system memory 1120 can be implemented using any suitable memory technology, such as random-access memory (RAM), static RAM (SRAM), synchronous dynamic RAM (SDRAM), nonvolatile/Flash-type memory, or any other type of memory. In the illustrated example, program instructions and data implementing one or more desired functions, such as those methods, techniques, and data described above, are shown stored within the system memory 1120 as speech-to-text service code 1125 (e.g., executable to implement, in whole or in part, the speech-to-text service 110) and data 1126.

In some examples, the I/O interface 1130 can be configured to coordinate I/O traffic between the processor 1110, the system memory 1120, and any peripheral devices in the device, including the network interface 1140 and/or other peripheral interfaces (not shown). In some examples, the I/O interface 1130 can perform any necessary protocol, timing, or other data transformations to convert data signals from one component (e.g., the system memory 1120) into a format suitable for use by another component (e.g., the processor 1110). In some examples, the I/O interface 1130 can include support for devices attached through various types of peripheral buses, such as a variant of the Peripheral Component Interconnect (PCI) bus standard or the Universal Serial Bus (USB) standard, for example. In some examples, the function of the I/O interface 1130 can be split into two or more separate components, such as a north bridge and a south bridge, for example. Also, in some examples, some or all of the functionality of the I/O interface 1130, such as an interface to the system memory 1120, can be incorporated directly into the processor 1110.

The network interface 1140 can be configured to allow data to be exchanged between the computing device 1100 and other computing devices 1160 attached to a network or networks 1150, such as other computer systems or devices as illustrated in FIG. 1, for example. In various examples, the network interface 1140 can support communication via any suitable wired or wireless general data networks, such as types of Ethernet network, for example. Additionally, the network interface 1140 can support communication via telecommunications/telephony networks, such as analog voice networks or digital fiber communications networks, via storage area networks (SANs), such as Fibre Channel SANs, and/or via any other suitable type of network and/or protocol.

In some examples, the computing device 1100 includes one or more offload cards 1170A or 1170B (including one or more processors 1175, and possibly including the one or more network interfaces 1140) that are connected using the I/O interface 1130 (e.g., a bus implementing a version of the Peripheral Component Interconnect-Express (PCI-E) standard, or another interconnect such as a QuickPath interconnect (QPI) or UltraPath interconnect (UPI)). For example, in some examples the computing device 1100 can act as a host electronic device (e.g., operating as part of a hardware virtualization service) that hosts compute resources such as compute instances, and the one or more offload cards 1170A or 1170B execute a virtualization manager that can manage compute instances that execute on the host electronic device. As an example, in some examples the offload card(s) 1170A or 1170B can perform compute instance management operations, such as pausing and/or un-pausing compute instances, launching and/or terminating compute instances, performing memory transfer/copying operations, etc. These management operations can, in some examples, be performed by the offload card(s) 1170A or 1170B in coordination with a hypervisor (e.g., upon a request from a hypervisor) that is executed by the other processors 1110A-1110N of the computing device 1100. However, in some examples the virtualization manager implemented by the offload card(s) 1170A or 1170B can accommodate requests from other entities (e.g., from compute instances themselves), and cannot coordinate with (or service) any separate hypervisor.

In some examples, the system memory 1120 can be one example of a computer-accessible medium configured to store program instructions and data as described above. However, in other examples, program instructions and/or data can be received, sent, or stored upon different types of computer-accessible media. Generally, a computer-accessible medium can include any non-transitory storage media or memory media such as magnetic or optical media, e.g., disk or DVD/CD coupled to the computing device 1100 via the I/O interface 1130. A non-transitory computer-accessible storage medium can also include any volatile or non-volatile media such as RAM (e.g., SDRAM, double data rate (DDR) SDRAM, SRAM, etc.), read only memory (ROM), etc., that can be included in some examples of the computing device 1100 as the system memory 1120 or another type of memory. Further, a computer-accessible medium can include transmission media or signals such as electrical, electromagnetic, or digital signals, conveyed via a communication medium such as a network and/or a wireless link, such as can be implemented via the network interface 1140.

Various examples discussed or suggested herein can be implemented in a wide variety of operating environments, which in some cases can include one or more user computers, computing devices, or processing devices which can be used to operate any of a number of applications. User or client devices can include any of a number of general-purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and/or other devices capable of communicating via a network.

Most examples use at least one network that would be familiar to those skilled in the art for supporting communications using any of a variety of widely available protocols, such as Transmission Control Protocol/Internet Protocol (TCP/IP), File Transfer Protocol (FTP), Universal Plug and Play (UPnP), Network File System (NFS), Common Internet File System (CIFS), Extensible Messaging and Presence Protocol (XMPP), AppleTalk, etc. The network(s) can include, for example, a local area network (LAN), a wide-area network (WAN), a virtual private network (VPN), the Internet, an intranet, an extranet, a public switched telephone network (PSTN), an infrared network, a wireless network, and any combination thereof.

In examples using a web server, the web server can run any of a variety of server or mid-tier applications, including HTTP servers, File Transfer Protocol (FTP) servers, Common Gateway Interface (CGI) servers, data servers, Java servers, business application servers, etc. The server(s) also can be capable of executing programs or scripts in response requests from user devices, such as by executing one or more Web applications that can be implemented as one or more scripts or programs written in any programming language, such as Java®, C, C#or C++, or any scripting language, such as Perl, Python, PHP, or TCL, as well as combinations thereof. The server(s) can also include database servers, including without limitation those commercially available from Oracle (R), Microsoft (R), Sybase (R), IBM (R), etc. The database servers can be relational or non-relational (e.g., “NoSQL”), distributed or non-distributed, etc.

Environments disclosed herein can include a variety of data stores and other memory and storage media as discussed above. These can reside in a variety of locations, such as on a storage medium local to (and/or resident in) one or more of the computers or remote from any or all of the computers across the network. In a particular set of examples, the information can reside in a storage-area network (SAN) familiar to those skilled in the art. Similarly, any necessary files for performing the functions attributed to the computers, servers, or other network devices can be stored locally and/or remotely, as appropriate. Where a system includes computerized devices, each such device can include hardware elements that can be electrically coupled via a bus, the elements including, for example, at least one central processing unit (CPU), at least one input device (e.g., a mouse, keyboard, controller, touch screen, or keypad), and/or at least one output device (e.g., a display device, printer, or speaker). Such a system can also include one or more storage devices, such as disk drives, optical storage devices, and solid-state storage devices such as random-access memory (RAM) or read-only memory (ROM), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or web browser. It should be appreciated that alternate examples can have numerous variations from that described above. For example, customized hardware might also be used and/or particular elements might be implemented in hardware, software (including portable software, such as applets), or both. Further, connection to other computing devices such as network input/output devices can be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (EEPROM), flash memory or other memory technology, Compact Disc-Read Only Memory (CD-ROM), Digital Versatile Disk (DVD) or other optical storage, magnetic cassettes, magnetic tape, magnetic disk storage or other magnetic storage devices, or any other medium which can be used to store the desired information and which can be accessed by a system device. Based on the disclosure and teachings provided herein, a person of ordinary skill in the art will appreciate other ways and/or methods to implement the various examples.

In the preceding description, various examples are described. For purposes of explanation, specific configurations and details are set forth to provide a thorough understanding of the examples. However, it will also be apparent to one skilled in the art that the examples can be practiced without the specific details. Furthermore, well-known features can be omitted or simplified in order not to obscure the example being described.

Bracketed text and blocks with dashed borders (e.g., large dashes, small dashes, dot-dash, and dots) are used herein to illustrate optional aspects that add additional features to some examples. However, such notation should not be taken to mean that these are the only options or optional operations, and/or that blocks with solid borders are not optional in certain examples.

Reference numerals with suffix letters (e.g., 1018A-1018N) can be used to indicate that there can be one or multiple instances of the referenced entity in various examples, and when there are multiple instances, each does not need to be identical but may instead share some general traits or act in common ways. Further, the particular suffixes used are not meant to imply that a particular amount of the entity exists unless specifically indicated to the contrary. Thus, two entities using the same or different suffix letters might or might not have the same number of instances in various examples.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” is intended to be understood to mean either A, B, or C, or any combination thereof (e.g., A, B, and/or C). Similarly, language such as “at least one or more of A, B, and C” (or “one or more of A, B, and C”) is intended to be understood to mean A, B, or C, or any combination thereof (e.g., A, B, and/or C). As such, disjunctive language is not intended to, nor should it be understood to, imply that a given example requires at least one of A, at least one of B, and at least one of C to each be present.

As used herein, the term “based on” (or similar) is an open-ended term used to describe one or more factors that affect a determination or other action. It is to be understood that this term does not foreclose additional factors that may affect a determination or action. For example, a determination may be solely based on the factor(s) listed or based on the factor(s) and one or more additional factors. Thus, if an action A is “based on” B, it is to be understood that B is one factor that affects action A, but this does not foreclose the action from also being based on one or multiple other factors, such as factor C. However, in some instances, action A may be based entirely on B.

Unless otherwise explicitly stated, articles such as “a” or “an” should generally be interpreted to include one or multiple described items. Accordingly, phrases such as “a device configured to” or “a computing device” are intended to include one or multiple recited devices. Such one or more recited devices can be collectively configured to carry out the stated operations. For example, “a processor configured to carry out operations A, B, and C” can include a first processor configured to carry out operation A working in conjunction with a second processor configured to carry out operations B and C, where the second processor could be part of same computing device as the first processor or part of a separate computing device as the first processor.

Further, the words “may” or “can” are used in a permissive sense (i.e., meaning having the potential to), rather than the mandatory sense (i.e., meaning must). The words “include,” “including,” and “includes” are used to indicate open-ended relationships and therefore mean including, but not limited to. Similarly, the words “have,” “having,” and “has” also indicate open-ended relationships, and thus mean having, but not limited to. The terms “first,” “second,” “third,” and so forth as used herein are used as labels for the nouns that they precede, and do not imply any type of ordering (e.g., spatial, temporal, logical, etc.) unless such an ordering is otherwise explicitly indicated. Similarly, the values of such numeric labels are generally not used to indicate a required amount of a particular noun in the claims recited herein, and thus a “fifth” element generally does not imply the existence of four other elements unless those elements are explicitly included in the claim or it is otherwise made abundantly clear that they exist.

The specification and drawings are, accordingly, to be regarded in an illustrative rather than a restrictive sense. It will, however, be evident that various modifications and changes can be made thereunto without departing from the broader scope of the disclosure as set forth in the claims.

What is claimed is:

1. A computer-implemented method comprising:
receiving a request to perform speech-to-text using a speech-to-text service to generate a transcript from an audio stream;
performing speech-to-text according to the request using the speech-to-text service to generate the transcript from the audio stream by:
determining a compute instance to send the request to based, at least in part, on availability information maintained, by a backend of the speech-to-text service, in a distributed routing cache for a plurality of compute instances and types of speech-to-text processing indicated by the request,
sending the request to the determined compute instance, wherein the determined compute instance is to utilize a model cache to dynamically switch speech-to-text models, and
processing the request using the determined compute instance to generate the transcript; and
providing the transcript as indicated by the request.

2. The computer-implemented method of claim 1, wherein the request includes one or more of an indication of a language being used, an indication of a latency that is acceptable, an indication of where the audio stream is located, and/or an indication of the types of speech-to-text operations to perform.

3. The computer-implemented method of claim 1, further comprising:
re-balancing one or more models of the compute instance by storing state of, and terminating, at least one model and restoring state of, and starting, at least one model.

4. A computer-implemented method comprising:
receiving a request to perform speech-to-text (STT) using a speech-to-text service to generate a transcript from an audio stream;
performing speech-to-text according to the request using the speech-to-text service to generate the transcript from the audio stream by:
determining a compute instance to send the request to based, at least in part, on availability information maintained in a distributed routing cache for a plurality of compute instances and types of speech-to-text processing indicated by the request,
sending the request to the determined compute instance, and
processing the request using the determined compute instance to generate the transcript; and
providing the transcript as indicated by the request.

5. The computer-implemented method of claim 4, wherein the request includes one or more of an indication of a language being used, an indication of a latency that is acceptable, an indication of where the audio stream is located, an indication of one or more custom models to use for speech-to-text operations, and/or an indication of the types of speech-to-text operations to perform.

6. The computer-implemented method of claim 4, wherein the indication of the types of speech-to-text operations to perform includes an automatic speed recognition (ASR) operation to be performed by an ASR model.

7. The computer-implemented method of claim 4, wherein the indication of the types of speech-to-text operations to perform includes a punction operation to add punction to the transcript to be performed by a punctuation model.

8. The computer-implemented method of claim 4, wherein the indication of the types of speech-to-text operations to perform includes a diarization operation to add one or more speakers to the transcript to be performed by a diarization model.

9. The computer-implemented method of claim 8, wherein the indication of the types of speech-to-text operations to perform includes a speaker error correction operation to correct alignment of the one or more speakers to the transcript to be performed by a speaker error correction model.

10. The computer-implemented method of claim 4, wherein the indication of the types of speech-to-text operations to perform includes a speech segmentation model to identify boundaries of at least words in the audio stream.

11. The computer-implemented method of claim 4, further comprising:
re-balancing based at least in part on speech-to-text traffic one or more models of the compute instance by storing state of, and stopping, at least one model and restoring state of, and re-starting, at least one model.

12. The computer-implemented method of claim 11, wherein the state is stored to local memory of the compute instance.

13. The computer-implemented method of claim 4, wherein the speech-to-text service supports a plurality of languages and types of models.

14. The computer-implemented method of claim 4, wherein the distributed routing cache for a plurality of compute instances is maintained by a backend of the speech-to-text service which updates the distributed routing cache for a plurality of compute instances upon model availability.

15. The computer-implemented method of claim 4, wherein the distributed routing cache has a plurality of slot types based on complexity of the STT operations to perform.

16. The computer-implemented method of claim 4, further comprising:
autoscaling compute instances based at least in part on information in the distributed routing cache for busy versus free slots of each available compute instance.

17. A system comprising:
a first one or more computing devices to implement a storage service in a multi-tenant provider network; and
a second one or more computing devices to implement a speech-to-text service in the multi-tenant provider network, the speech-to-text service including instructions that upon execution cause the speech-to-text service to:
perform speech-to-text according to the request using the speech-to-text service to generate the transcript, to be stored in the storage service, from the audio stream to:
determine a compute instance to send the request to based, at least in part, on availability information maintained in a distributed routing cache for a plurality of compute instances and types of speech-to-text processing indicated by the request,
send the request to the determined compute instance, and
process the request using the determined compute instance to generate the transcript; and
provide the transcript as indicated by the request.

18. The system of claim 17, wherein the speech-to-text service is to support a plurality of languages and types of models.

19. The system of claim 17, wherein the request includes one or more of an indication of a language being used, an indication of a latency that is acceptable, an indication of where the audio stream is located, an indication of one or more custom models to use for speech-to-text operations, and/or an indication of the types of speech-to-text operations to perform.

20. The system of claim 17, further comprising:
chat service to receive the audio stream.
